(19) United States
(12) Patent Application Publication
(10) Pub. No.: US 2022/0198396 A1
(43) Pub. Date: Jun. 23, 2022

(54) ACCESS CONTROL METHODS FOR COLLABORATIVE EDITING VIA MULTIPLE USER INTERFACES

(71) Applicant: Canva Pty Ltd, Surry Hills (AU)

(72) Inventors: Clifford Obrecht, Sydney (AU); Melanie Joy Perkins, Sydney (AU)

(21) Appl. No.: 17/681,831

(22) Filed: Feb. 27, 2022

Related U.S. Application Data
(63) Continuation of application No. 15/574,123, filed on Nov. 14, 2017.
(60) Provisional application No. 62/162,500, filed on May 15, 2015.

(51) Int. Cl. G06Q 10/10; G06F 3/04845; G06Q 30/02; G06F 21/62; G06Q 10/06

(52) U.S. Cl. CPC G06Q 10/103; G06F 3/04845; G06Q 30/02; G06F 2221/2113; G06Q 10/101; G06Q 10/063118; G06F 21/6218

(57) ABSTRACT

Access control methods for collaborative editing via multiple user interfaces are disclosed. One such method for editing a design kit for marketing materials includes a first user interface including respective display regions simultaneously displaying at least two of a set of colors, fonts, and logos, the sets each including existing set colors, fonts, and logos, respectively, and a selectable indicium associated with an operation of editing the set of colors, fonts, and logos, respectively, for the design kit. The method also includes maintaining an association with designs or templates that incorporate the stored colors, fonts and/or logos of the design kit. The method causing an updated design kit to be displayed in a second user interface for a second user for use in editing the design or template. The first and second user interfaces are displayed on two different electronic devices connected to one another via a network.

### CROSS-REFERENCE TO RELATED APPLICATIONS

This application is a U.S. continuation application that claims the benefit of the filing date of U.S. National Stage application Ser. No. 15/574,123, filed Nov. 14, 2017, that claims priority to International PCT Application No. PCT/US2016/032798, filed May 16, 2016, that in turn claims priority to U.S. Provisional Application No. 62/162,500, filed May 15, 2015, that are each hereby incorporated by reference in their entirety.

### FIELD OF THE INVENTION

The present disclosure relates generally to brand creation and management, and more specifically to a multi-user design collaboration system for creating brand capital.

### BACKGROUND

In the graphic design process, a team of designers need to collaborate for a period of time to make several iterations of branding for a company. Team members have to search for stock graphics, purchase selected graphics, search for fonts, purchase and install the fonts, cut and prepare the stock graphics, create and design graphics in a pixel or vector based program, layout the final design before, select colors and typefaces to produce one or more ideas that need to be approved or revised. Then the accepted branding capital needs to be distributed throughout the company as a standard for all branded communications for the company. For the designer team, this process is time consuming and requires a substantial amount of training and experience across a number of graphic design programs and websites. The transferring of bits and pieces from one team member to another requires multiple copies of expensive design programs and risks corruption of the files or delays if every team member does not have exactly the same program or copy of the project files. This increases the cost and time involved in creating design assets and can be cost prohibitive to many use cases. Even currently available standard document management systems fail to provide collaboration across team members or allow simultaneous work on a single project. Additionally, any changes in the design can require repeating the design steps, and in the case of any changes to the design can increase the cost of the final design.

Therefore, there is a need for a multi-user design collaboration system for creating brand capital.

### SUMMARY

The present disclosure overcomes the limitations of the prior art by providing a multi-user design collaboration system for creating brand capital. The system has one or more than one computing device with a processor, memory and storage capable of executing instructions for presenting a user interface to one or more than one user. One or more than one server is connected to the computing device for storing, executing and distributing instructions.

The stored instructions are executable on the one or more than one computing device and the one or more than one server. The executable instructions, when executed cause the computing device to: log an administrator onto the system; create a team by the administrator; select, create, or both select and create the colors, fonts and logos for a branding kit; add, create or both add and create templates for the branding kit; define and add user roles for team members; invite team members to participate in a design and branding process; upload existing branding capital for use by the team; access the system by the team within the assigned role to work on the design; stream a team member's completed parts of the branding capital to the team's homepage for all the other team members to access; edit all the various design elements to complete the branding kit by the team; review the completed branding kit and marketing material; share the completed branding kit and marketing material; authorize the branding kit and marketing material; and publish the branding kit and marketing material.

Additionally, a remote storage can be attached to the server for storing branding capital and instructions that are distributable to the computing device. Branding capital design elements can be stored in a local storage on the computing device, the server, the remote storage or a combination of the computing device, the server and the remote storage. Indicia of user roles are stored in the remote storage for use by the computing device and the server. The indicia of user roles restrict access to the branding capital and the user's ability to modify the branding capital. In some instances, the remote storage is a third party market place.

There is also provided a method for using a multi-user design collaboration system for creating brand capital. First an administrator logs onto the system and creates a team. Then, the administrator can select, create, or both select and create the colors, fonts and logos for a branding kit. The administrator can also add, create or both add and create templates for the branding kit and also define and add user roles for team members. Then, team members are invited to participate in the design and branding process by the administrator. The team can upload existing branding design elements for use. The team accesses the system within an assigned role to work on the design. Team members can stream completed parts of the branding design to the team's homepage for all the other team members to access. The team edits all the various design elements to complete the branding kit. After the branding kit and marketing material are completed, it is reviewed, shared, authorized and then published for use.

A team color can be selected for the team homepage. This helps identify projects by team members that are working on multiple projects. Team member invitations can be to people that are internal, external only or both internal and external to the project.

The user roles are selected from the group consisting of administrator, publisher, editor, graphic artist, layout creator, team member, reviewer, and authorizer. Access to and modification of the branding capital is restricted using the indicia of user roles.

Branding capital can be accessed from a third party marketplace. The functionality of branding capital from the third party marketplace can be limited by constraints in the branding capital itself, or by the indicia or user roles. Additionally, the third party marketplace branding capital is automatically updated when it is changed in the third party marketplace.

### BRIEF DESCRIPTION OF THE DRAWINGS

These and other features, aspects and advantages of the present disclosure will become better understood with regard to the following description, appended claims, and accompanying figures where:

FIG. 1 is a schematic diagram of a multi-user design collaboration system for creating brand capital, according to one embodiment;

FIG. 2 is a flowchart diagram of a multi-user design collaboration system for creating brand capital, according to one embodiment;

FIG. 3 is a diagram of multi-user design collaboration roles for the system of

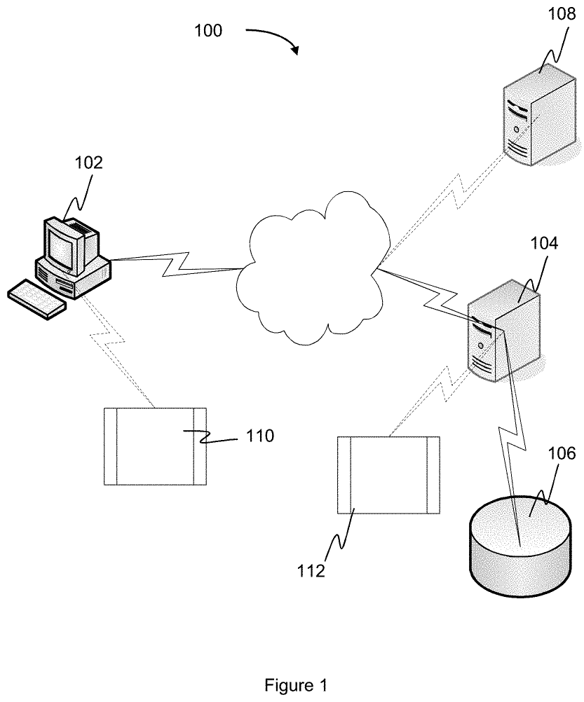

FIG. 1;

FIG. 4 is a screenshot of branding capital created by the system of FIG. 1;

FIG. 5 is a screenshot of a team administrator page;

FIG. 6 is a screenshot of a team portal;

FIG. 7 is a screenshot of a team page for inviting additional team members;

FIG. 8 is a screenshot of a team's brand kit;

FIG. 9 is a screenshot of a team's color palette;

FIG. 10 is a screenshot of a color palette selector module;

FIG. 11 is a screenshot of a font selection module;

FIG. 12 is a screenshot of a font editor module;

FIG. 13 is a screenshot of a template selection module;

FIG. 14 is a screenshot of a template creation module;

FIG. 15 is a screenshot of a template description and security setting module;

FIG. 16 is a screenshot of an image editor module;

FIG. 17 is a screenshot of a payment option module;

FIG. 18 is a screenshot of a payment module;

FIG. 19 is a screenshot of a new design font combination module;

FIG. 20 is a screenshot of the team homepage with the selected design from FIG. 19;

FIG. 21 is a screenshot of pre-sized design types selectable for use in a design;

FIG. 22 is a screenshot of a branding capital color palette selection module;

FIG. 23 is a screenshot of a layout selection module;

FIG. 24 is a screenshot of a layout customization module;

FIG. 25 is a screenshot of a text selection module;

FIG. 26 is a screenshot of a contextual text application module;

FIG. 27 is a screenshot of a background selection module;

FIG. 28 is a screenshot of a design sharing module;

FIG. 29 is a screenshot of a design publishing module;

FIG. 30 is a screenshot of a design streaming module;

FIG. 31 is a screenshot of a stream of designs on the team's homepage;

FIG. 32 is a screenshot of a first multi-user design collaboration system for creating branding capital workflow step;

FIG. 33 is a screenshot of a second multi-user design collaboration system for creating branding capital workflow step;

FIG. 34 is a screenshot of a third multi-user design collaboration system for creating branding capital workflow step;

FIG. 35 is a screenshot of a fourth multi-user design collaboration system for creating branding capital workflow step;

FIG. 36 is a screenshot of a fifth multi-user design collaboration system for creating branding capital workflow step;

FIG. 37 is a screenshot of a sixth multi-user design collaboration system for creating branding capital workflow step;

FIG. 38 is a screenshot of a seventh multi-user design collaboration system for creating branding capital workflow step;

FIG. 39 is a screenshot of an eighth multi-user design collaboration system for creating branding capital workflow step;

FIG. 40 is a screenshot of a tenth multi-user design collaboration system for creating branding capital workflow step;

FIG. 41 is a screenshot of an eleventh multi-user design collaboration system for creating branding capital workflow step;

FIG. 42 is a screenshot of a twelfth multi-user design collaboration system for creating branding capital workflow step;

FIG. 43 is a screenshot of a thirteenth multi-user design collaboration system for creating branding capital workflow step;

FIG. 44 is a screenshot of a fourteenth multi-user design collaboration system for creating branding capital workflow step;

FIG. 45 is a screenshot of a fifteenth multi-user design collaboration system for creating branding capital workflow step; and

FIG. 46 is a screenshot of a sixteenth multi-user design collaboration system for creating branding capital workflow step.

### DETAILED DESCRIPTION

The present disclosure overcomes the limitations of the prior art by providing a multi-user design collaboration system for creating brand capital. The system can create an integrated design process from design elements to final design use/export, where design elements can be fully monitored, shared and used company-wide. By maintaining a single design repository, the system provides powerful branding options that can enforce branding policies and usage of designs and design elements while making the design more widely available to other users.

The system helps create beautifully branded designs. Every brand faces the same problem: a desire to produce consistent marketing materials, social media graphics and documents with limited design resources.

The system is mutually beneficial to designers and to content providers of design elements. Designers have access to a wider variety of design elements but can only use the design elements that have been authorized by the administrator. This insures that any designs produced will conform to company branding guidelines, removing the problem of “rogue” marketing material. Once the design kit is complete, templates for all the various marketing projects can be easily accomplished by anyone in the company authorized to access the design kit. Additionally, the designs can be automatically entered into standard templates that can be printed at work or on the road. This allows the branding to be adjusted and new marketing material can be produced in a just in time manner. This saves the company the cost of ordering hundreds or thousands of marketing pieces that can change, leaving boxes of unusable material that goes to waste. Additionally, team members, from both inside the company and external consultants, can simultaneously work on branding designs and design elements within an ecosystem/platform that integrates a mechanism capable of enforcing role based rules. Resource control can be enforced so that the team administrator can control the manner that the design elements are used by other team members.

The branding design platform is provided for users to create designs using design elements from the system and other user supplied images, such as, for example, uploaded images. The design platform can be accessible through a web browser and/or a native application on the user's computing device. Once finished, an authorized team member can export/publish their design to a team home page for other team members to work on or review. Once the branding design is complete, the entire package can be easily shared and authorized by management, or edited to comply with a requested change. Then, the branding material can be published to a particular medium (e.g., digital file, publish to a website, print to physical medium, etc.).

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Systems and methods that implement the embodiments of the various features of the disclosure will now be described with reference to the drawings. The drawings and the associated descriptions are provided to illustrate embodiments of the disclosure and not to limit the scope of the disclosure. Reference in the specification to “one embodiment” or “an embodiment” is intended to indicate that a particular feature, structure, or characteristic described in connection with the embodiment is included in at least an embodiment of the disclosure. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments can be practiced without these specific details. Well-known structures and techniques cannot be shown in detail in order not to obscure the embodiments. For example, algorithms can be shown in block diagrams in order not to obscure the embodiments in unnecessary detail.

Also, it is noted that the embodiments can be described as a process that is depicted as a flowchart, a flow diagram, a structure diagram, or a block diagram. The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). Although a flowchart can describe the operations as a sequential process, many of the operations can be performed in parallel or concurrently. In addition, the order of the operations can be rearranged. A process is terminated when its operations are completed. A process can correspond to a method, a function, a procedure, a subroutine, a subprogram, etc. When a process corresponds to a function, its termination corresponds to a return of the function to the calling function or the main function.

Moreover, storage can represent one or more devices for storing data, including read-only memory (ROM), random access memory (RAM), magnetic disk storage mediums, optical storage mediums, flash memory devices and/or other machine readable mediums for storing information, such as, for example a database. The term “machine readable medium” includes, but is not limited to portable or fixed storage devices, optical storage devices, wireless channels and various other mediums capable of storing, containing or carrying instruction(s) and/or data.

Furthermore, embodiments can be implemented by hardware, software, firmware, middleware, microcode, or a combination thereof. When implemented in software, firmware, middleware or microcode, the program code or code segments to perform the necessary tasks can be stored in a non-transitory machine-readable medium such as a storage medium or other storage(s). One or more than one processor can perform the necessary tasks in series, distributed, concurrently or in parallel. A code segment can represent a procedure, a function, a subprogram, a program, a routine, a subroutine, a module, a software package, a class, or a combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted through a suitable means including memory sharing, message passing, token passing, network transmission, etc.

In the following description, certain terminology is used to describe certain features of one or more embodiments of the disclosure.

The term “branding capital” refers to any current or future multimedia files, design elements or objects including images, clip art, video and audio, fonts, design layouts, layouts that have several design elements from different content producers, text layouts, graphic templates, graphic files, photos, illustrations, vector graphics, icons, symbols, text layouts, graphic layouts, patterns and textures, 2D and 3D models, models with a kinetic model (e.g., a 2d or 3D model of a person that can be positioned into a variety of poses) and design effects.

The term “computing device” refers to desktop computers, laptop computers, smart phones, tablets and other mobile devices that comprise the ability to interact with the internet and execute instructions.

The term “publish” refers to finalizing a design containing design elements by saving the design, exporting the design to another format, creating an electric copy in a secure format, creating a web compatible version of the design, printing the design, downloading a copy, or any other method for completing the design project contemplated now or in the future.

Various embodiments provide a system for a multi-user design collaboration system for creating brand capital. In another embodiment, there is provided a method for using the system. The system and method will now be disclosed in detail.

Referring now to FIG. 1, there is shown a schematic diagram 100 of a multi-user design collaboration system for creating branding capital 400, according to one embodiment. The system 100 comprises one or more than one computing device 102 and 104 with a processor, memory and storage capable of executing instructions retrieved from one or more than one server 104 for presenting a user interface, shown below, for accessing and editing branding material by one or more than one user. In some instances, depending upon user rights, the branding design materials can be worked on simultaneously, or restricted to one user at a time to prevent conflicts at critical design stages. The branding design materials can be stored in a local storage on the one or more than one computing device 102 and 104 or the materials can be accessed from remote storage 106 attached to the one or more than one server 104, thereby expanding the availability of branding design materials for the design team. Optionally, the system 100 can be connected to a third party marketplace. Any branding capital 400 that is used from the third party marketplace can be automatically updated through the market place.

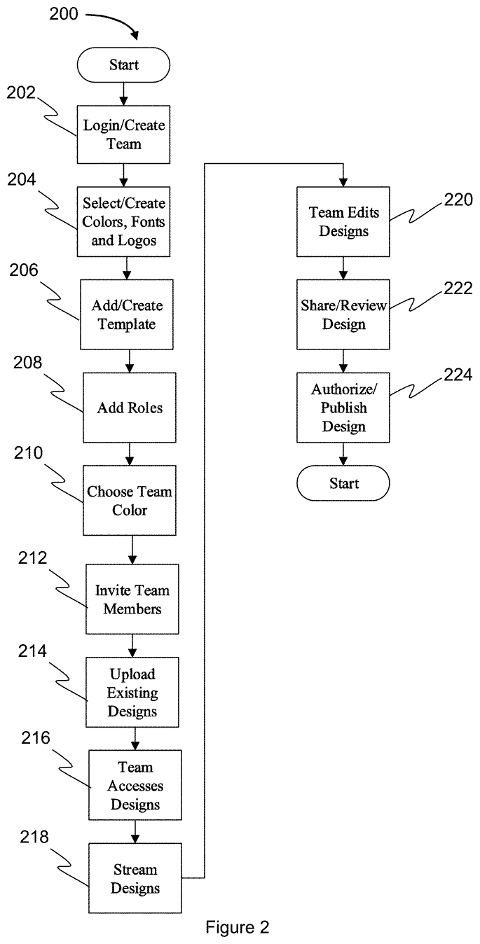

Referring now to FIG. 2, there is shown a flowchart diagram 200 of a multi-user design collaboration system for creating branding capital 400, according to one embodiment. First, an administrator 302 logs into the system to create a team 202. Then the administrator 302 can select or create the colors, fonts and logos for the initial branding kit 204. Then, templates can be added or created 206 for the branding kit. Next, user roles for the team are added 208 to the team. Optionally, a team color can be selected 210 for the team homepage. This allows different team members to work on multiple projects and have an easy way to identify the project that they are currently working on. Then, team members are invited 212 to participate in the design and branding process. Unlike other systems currently available, internal and external team members can work on the project. This allows companies to use independent contractors and specialists on selected projects, thereby reducing personnel costs and increasing project productivity. Next, existing branding design elements can be uploaded 214 for use by the team. This leverages any existing project materials that can then be re-purposed or expanded, saving the company time and money. Then, the team accesses the system 216 and works on the design within the role that they have been assigned, such as, for example, administrator 302, publisher, editor, graphic artist, etc. Next, when a team member completes part of the branding design it is sent to the team's homepage where it is streamed 218 for all the other team members to access. Then, the team edits 220 all the various design elements to complete the branding kit. Next, the completed branding kit and marketing material can be shared and/or reviewed 222. Finally, once all changes have been made and the branding kit and marketing material have been authorized 224 for use, the branding kit can be published for use by the rest of the company.

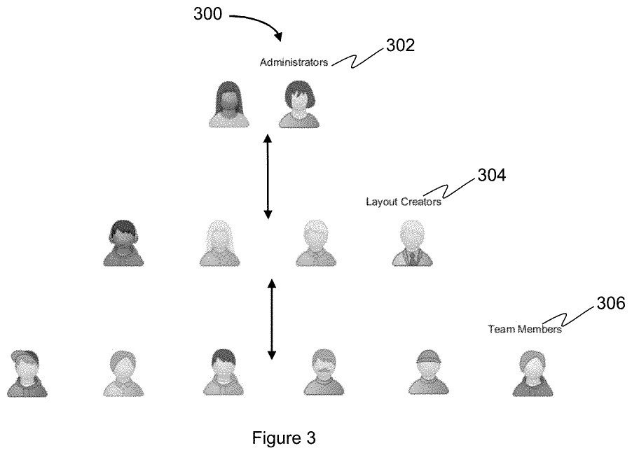

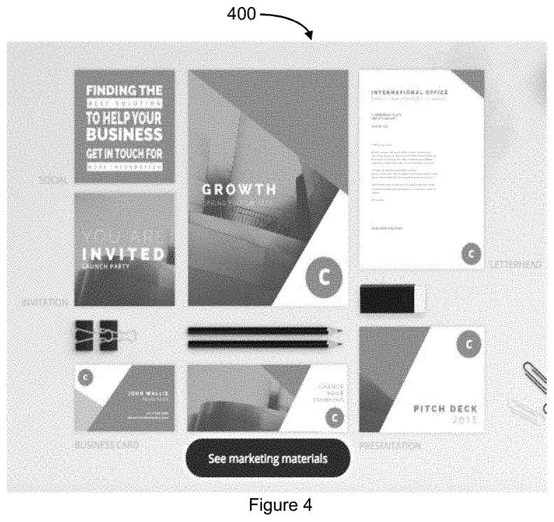

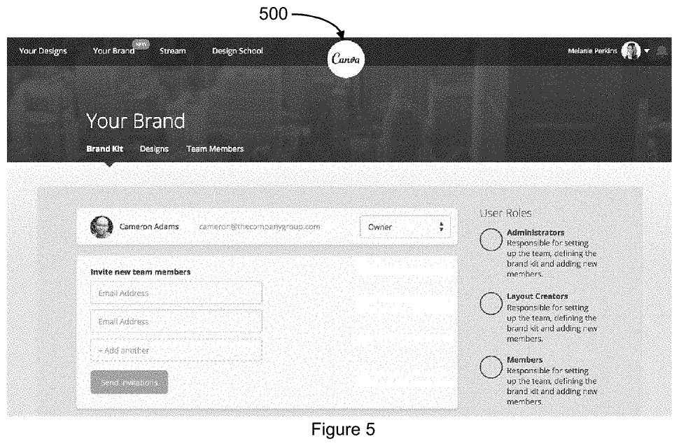

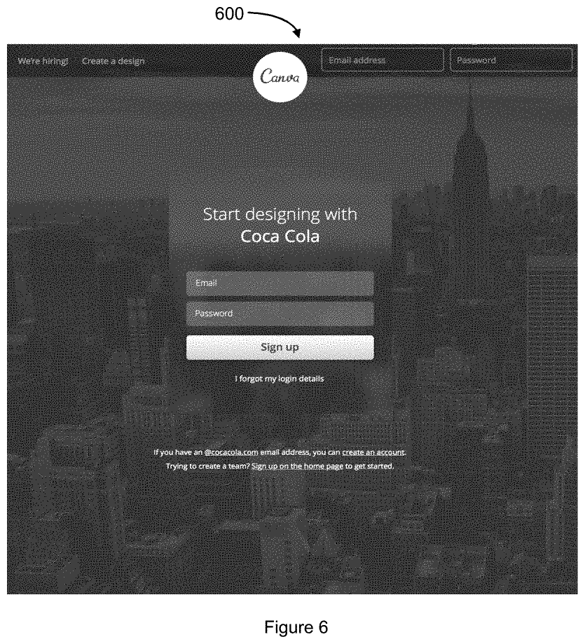

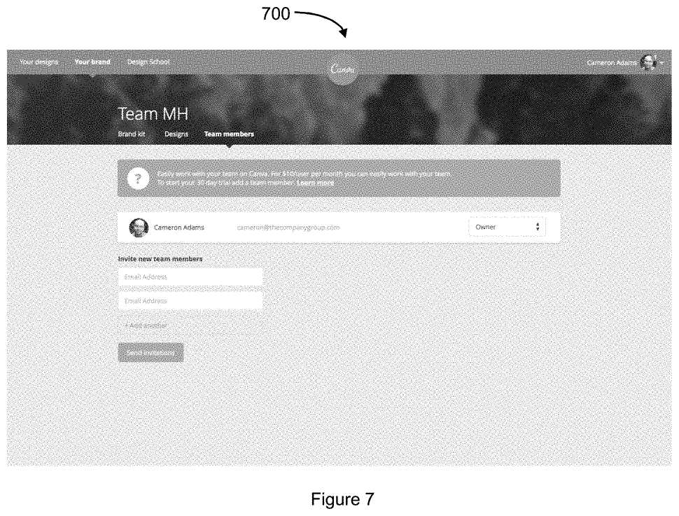

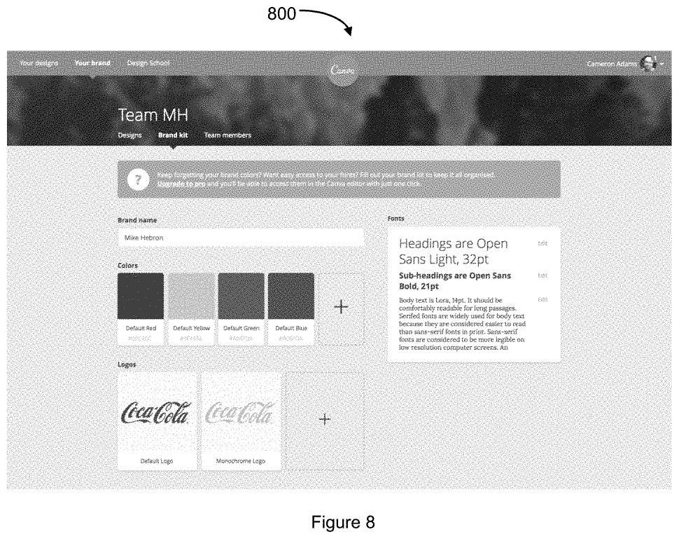

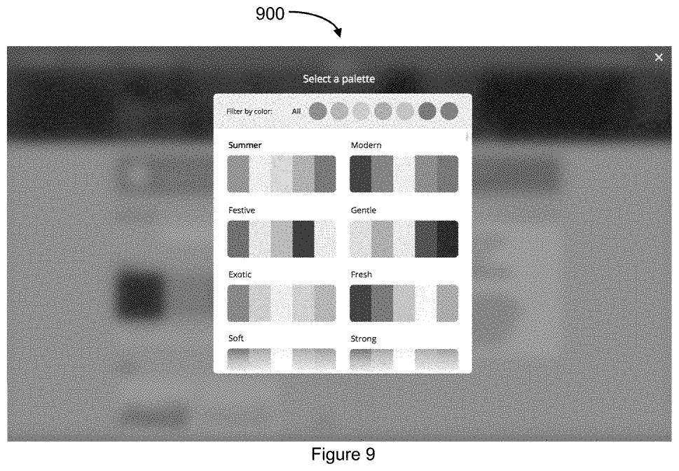

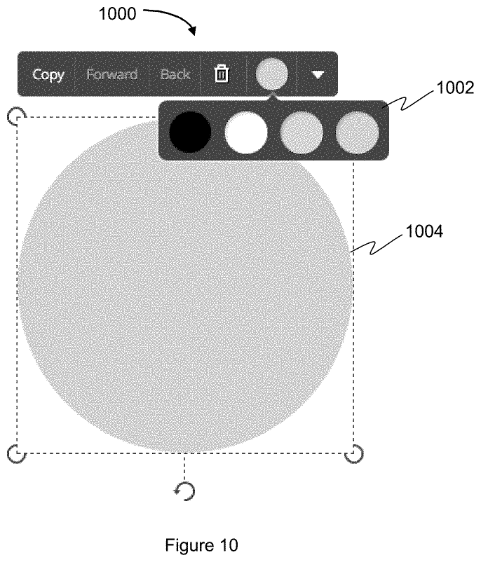

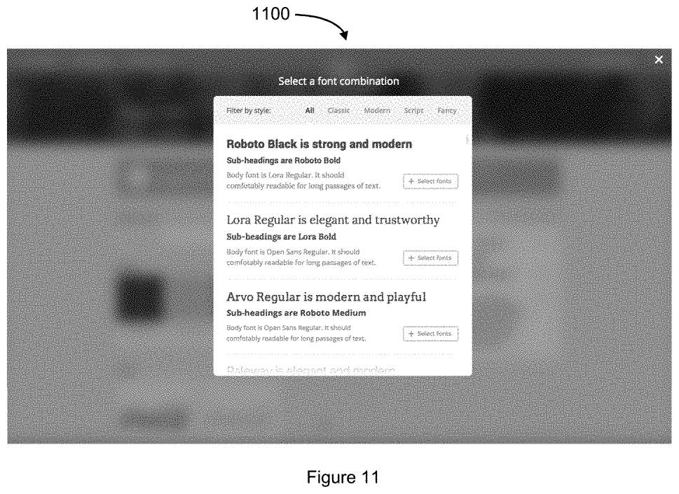

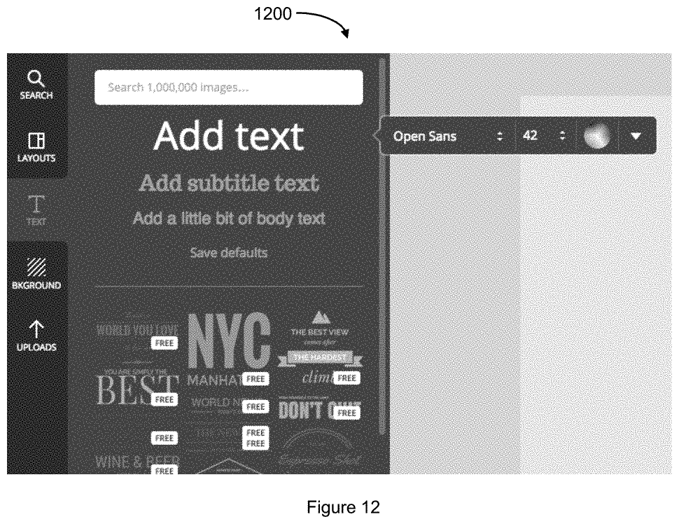

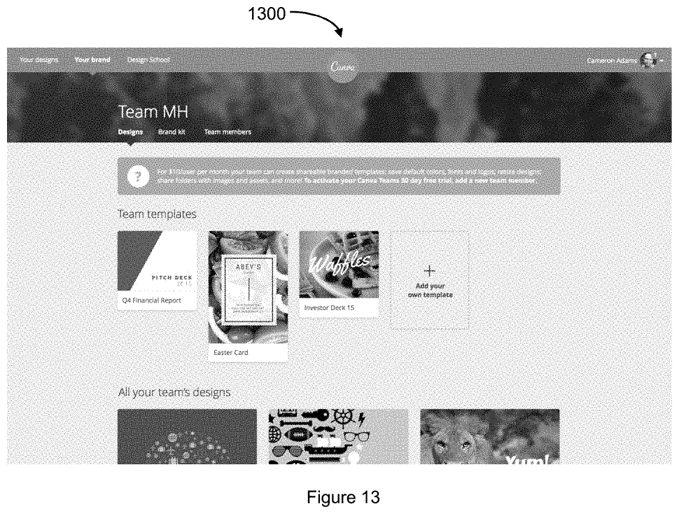

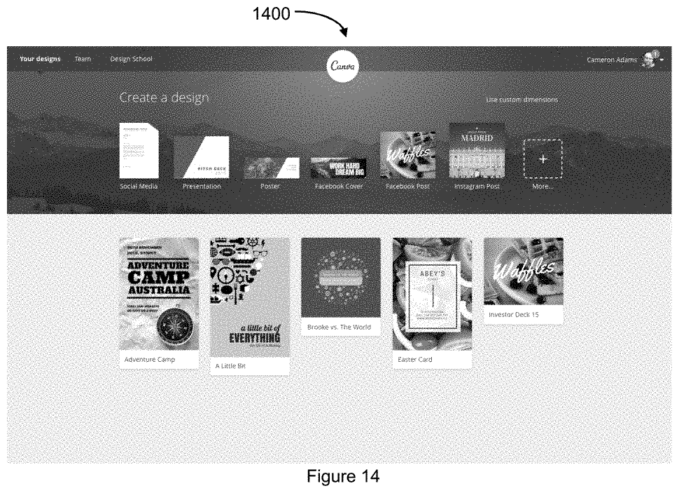

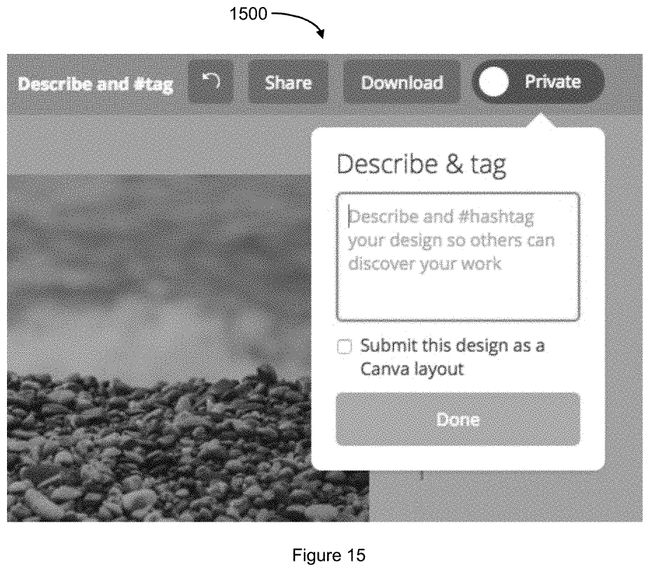

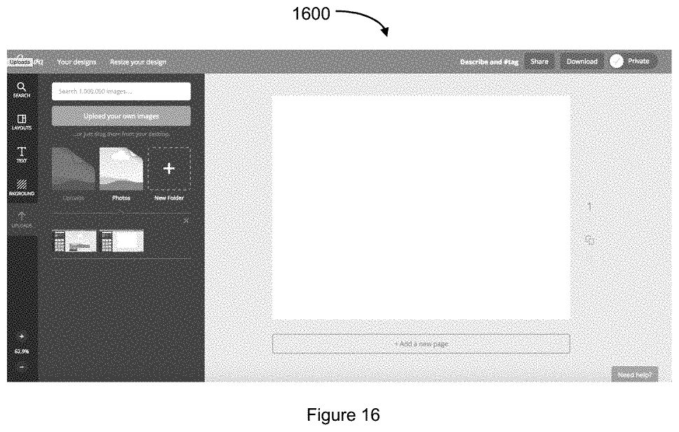

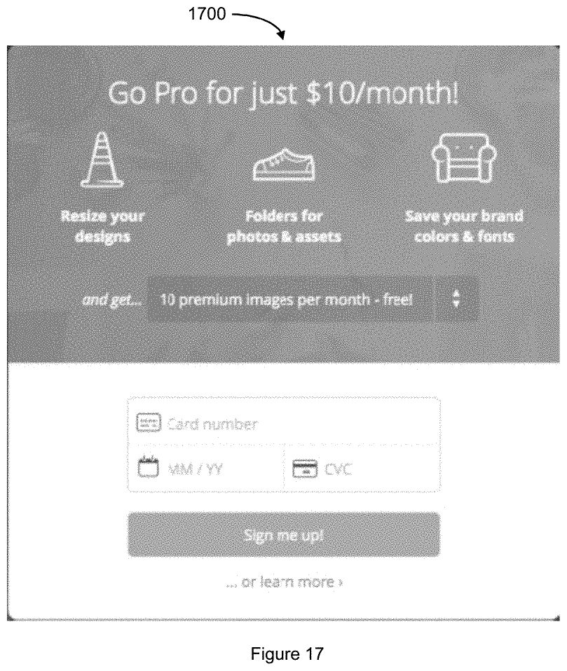

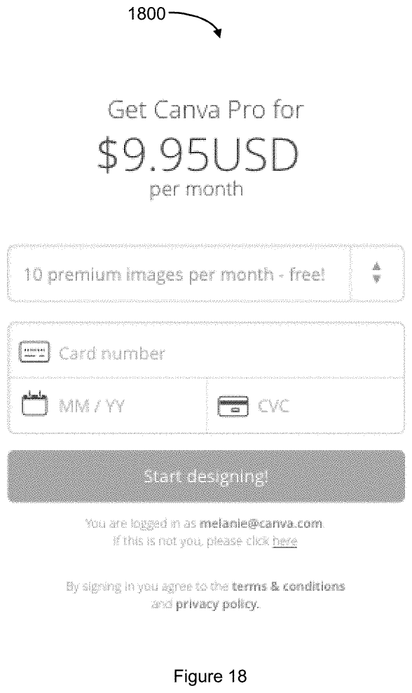

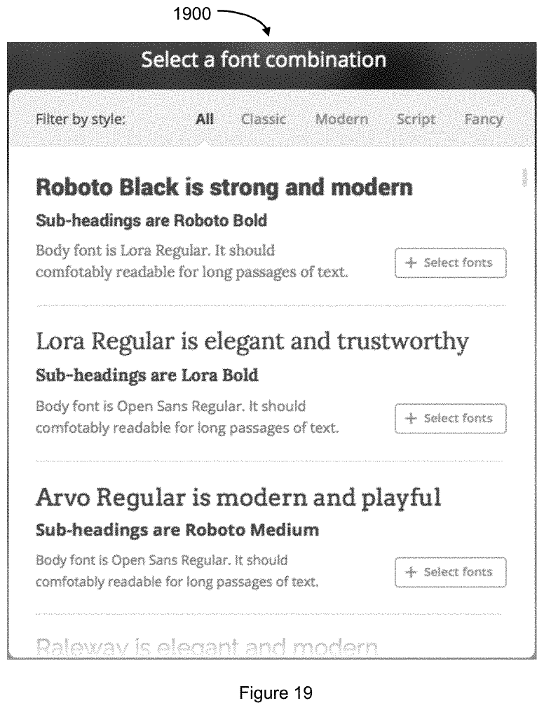

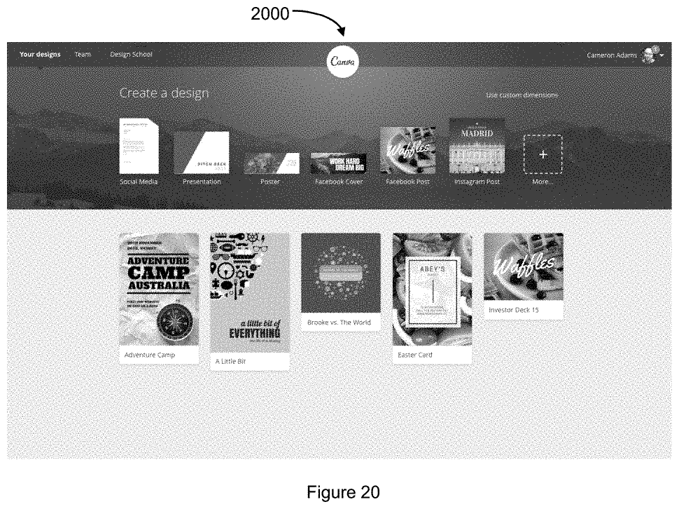

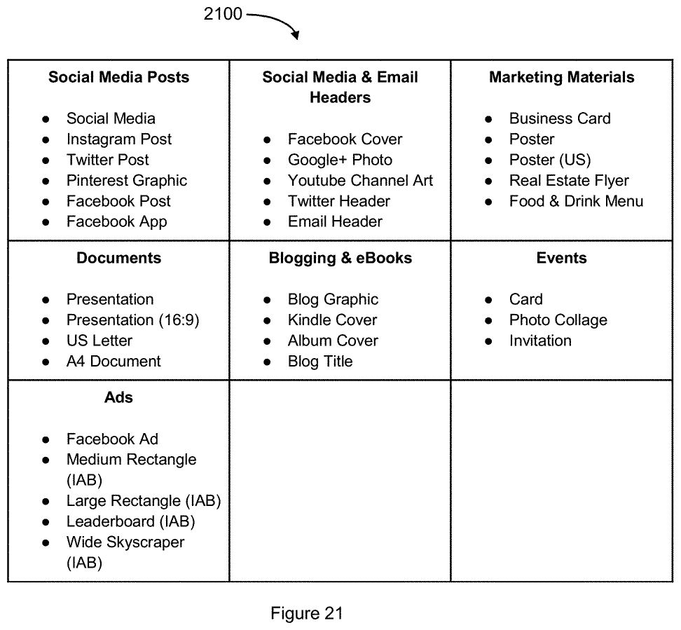

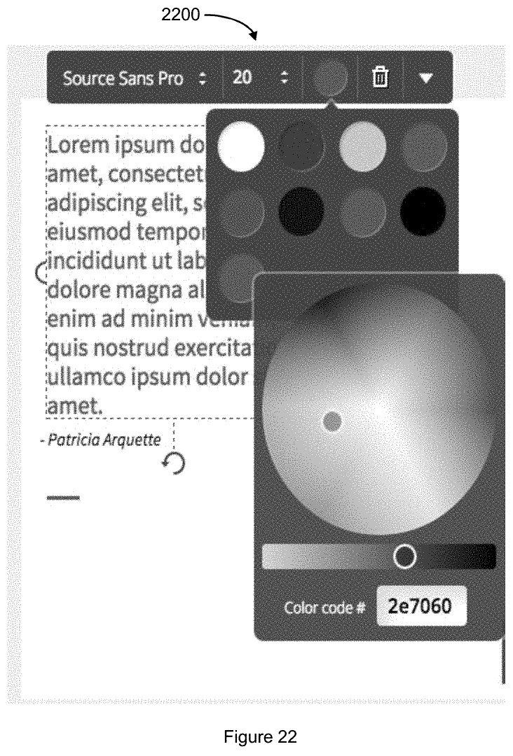

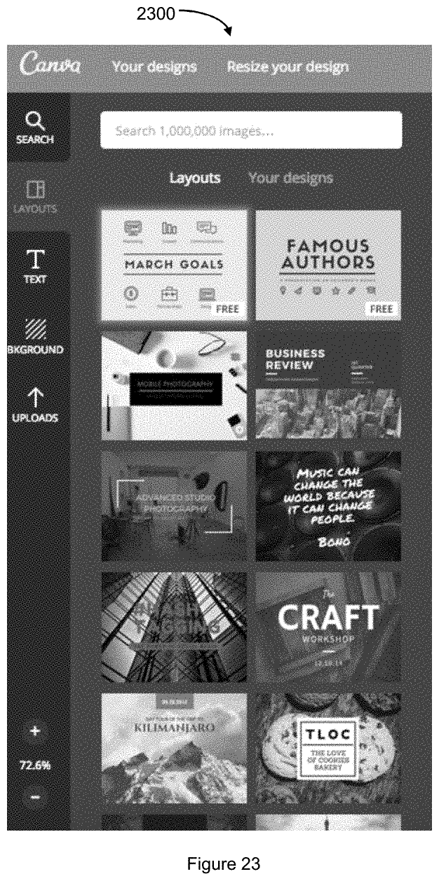

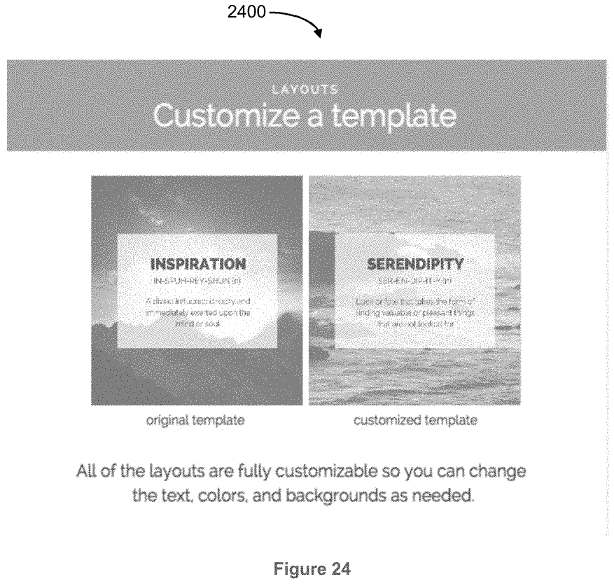

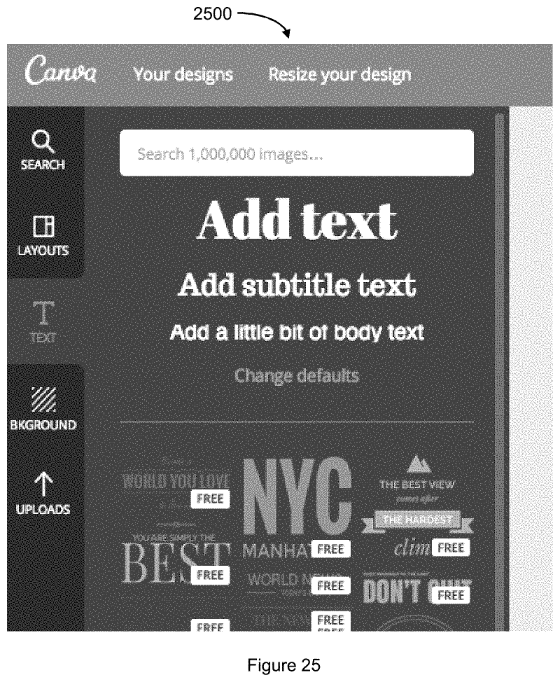

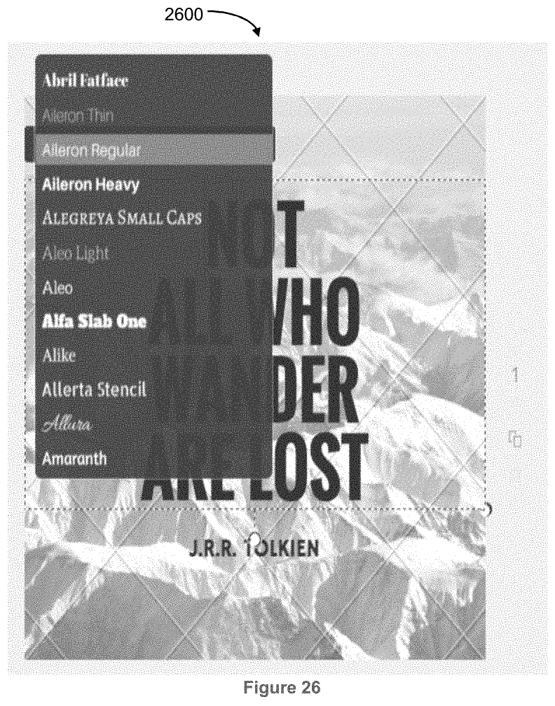

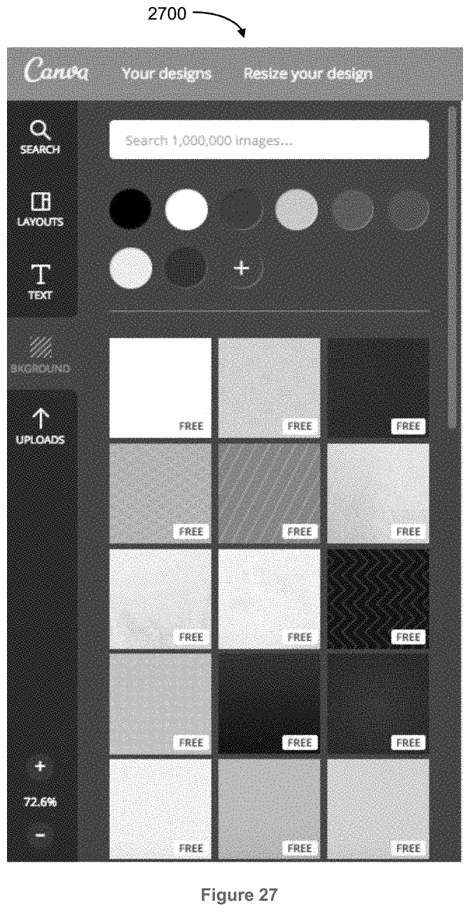

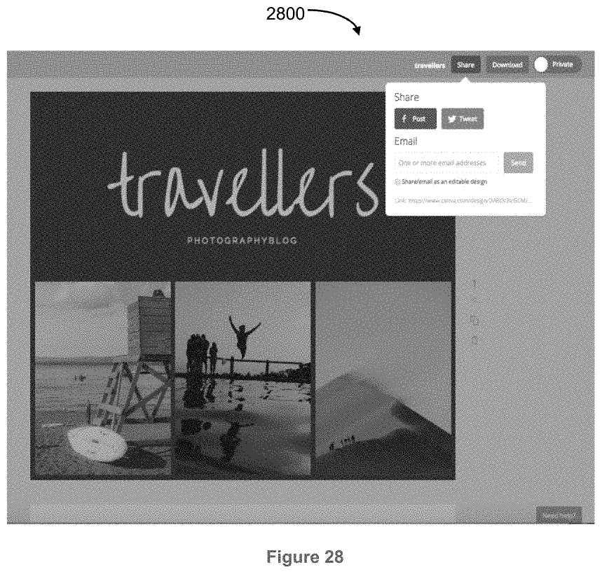

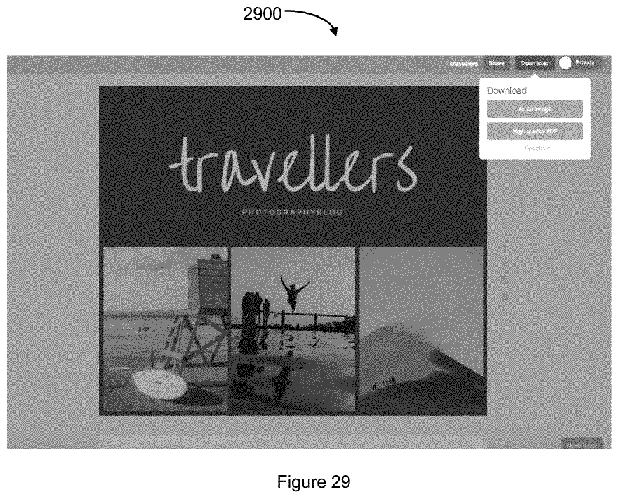

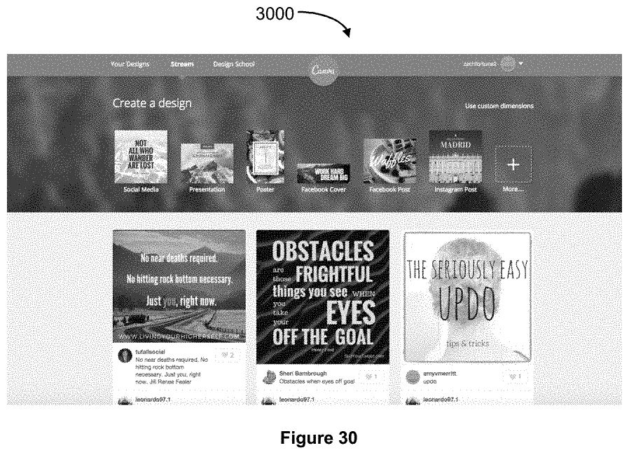

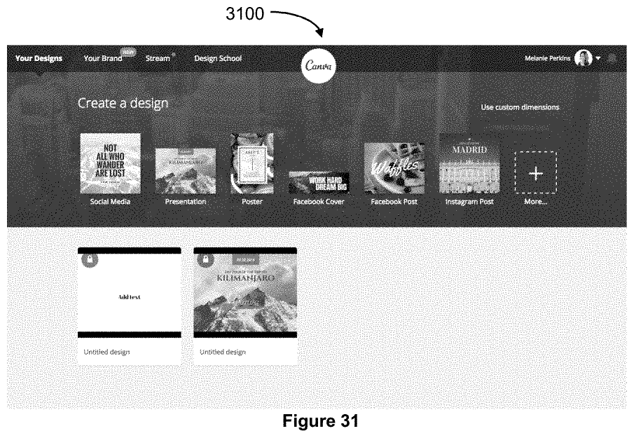

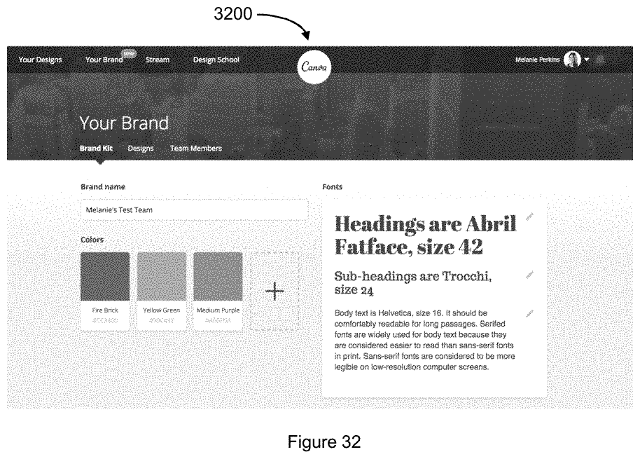

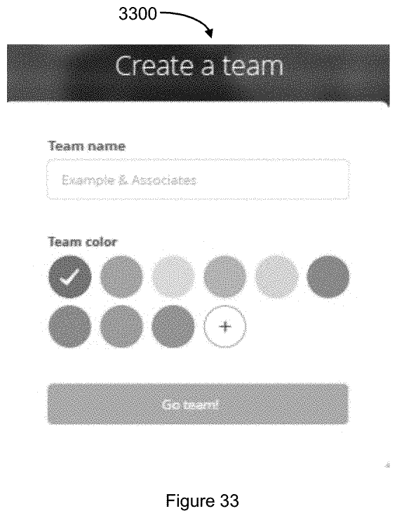

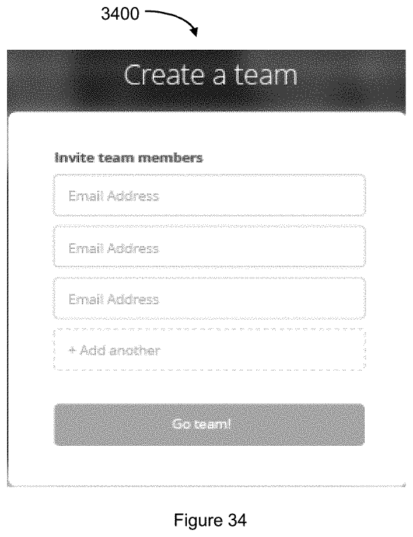

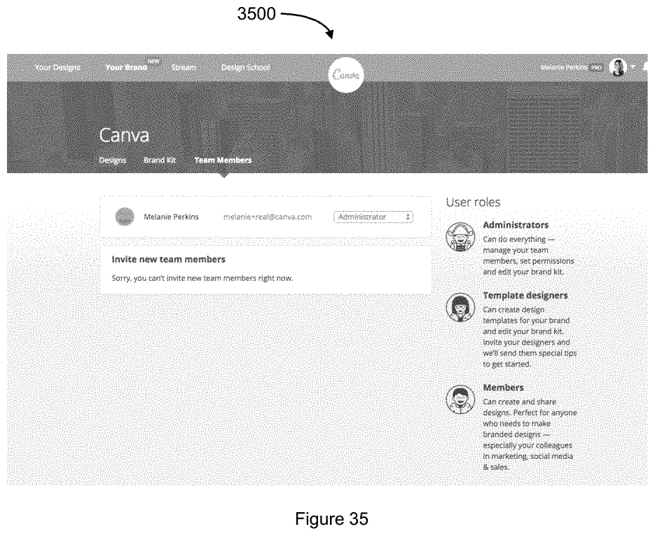

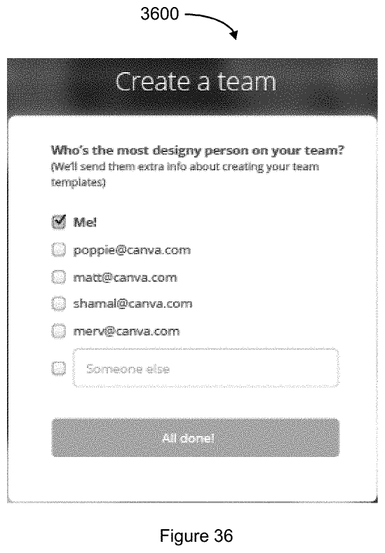

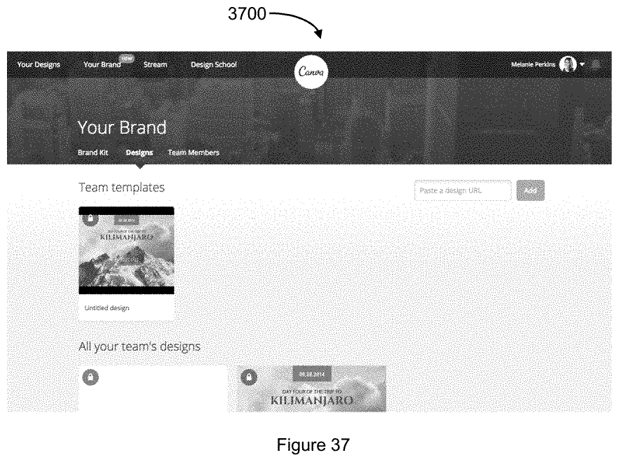

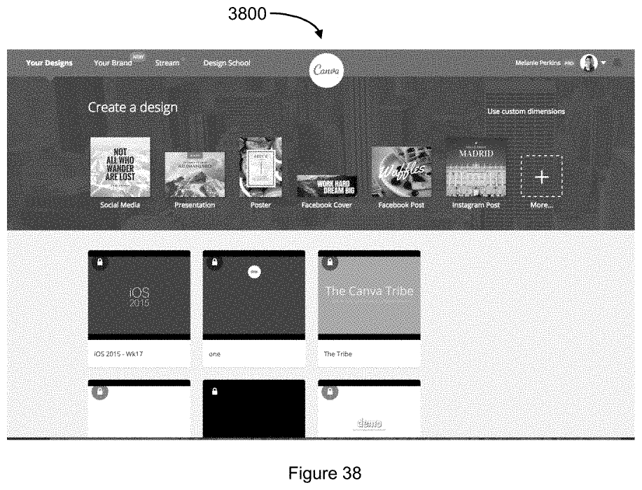

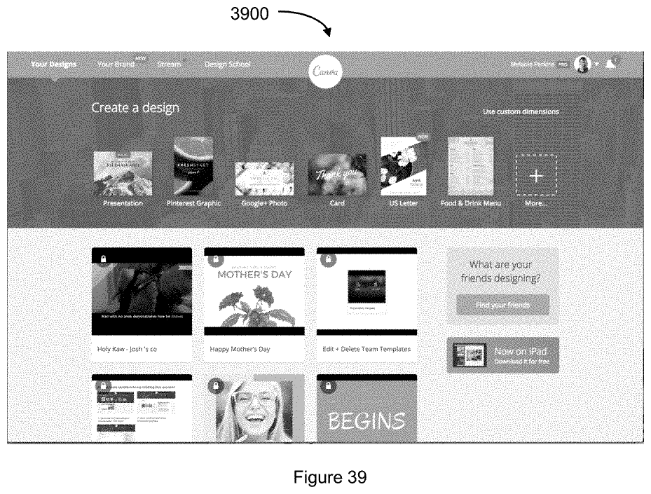

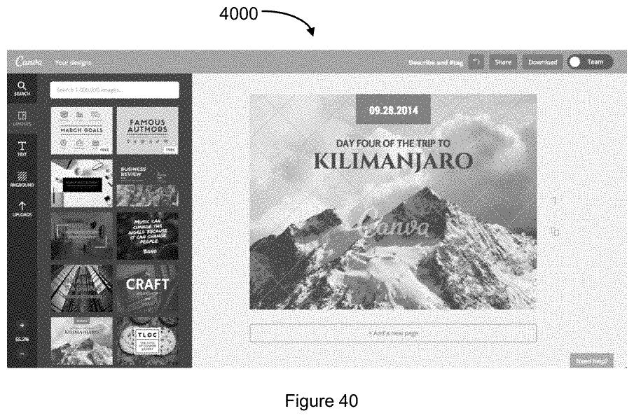

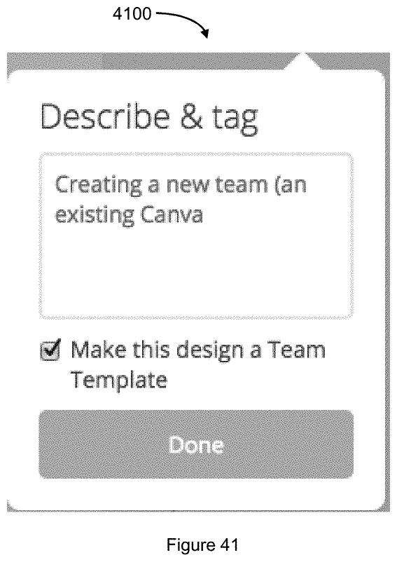

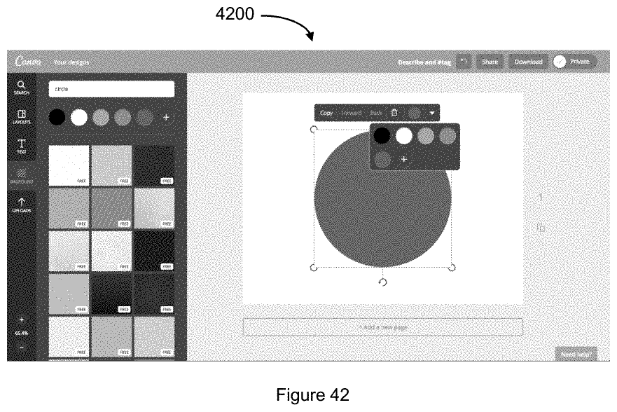

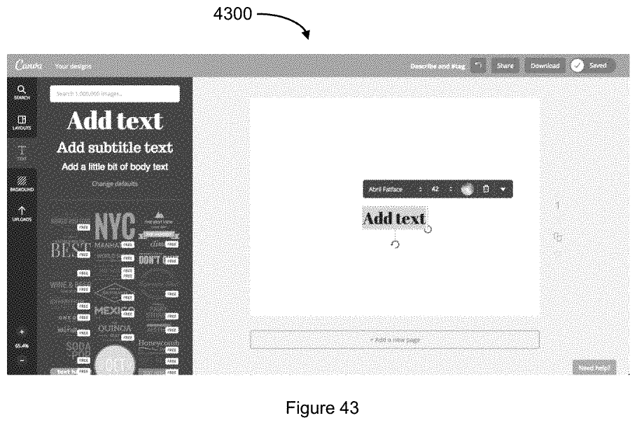

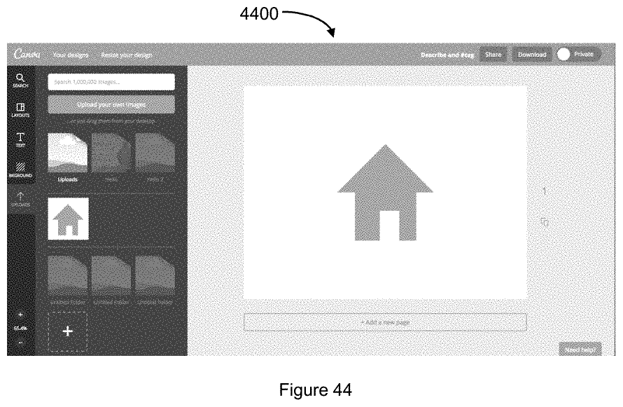

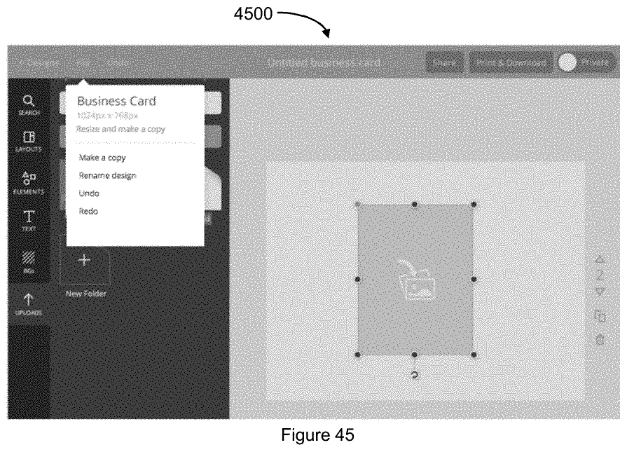

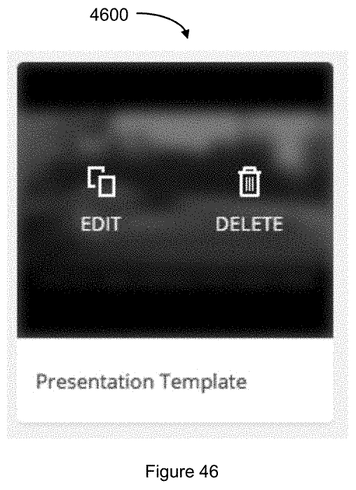

Referring now to FIG. 3, there is shown a diagram of multi-user design collaboration roles for the system of FIG. 1. As can be seen, there are at least three different user levels in the system 100. The system 100 comprises instructions to authorize access to the system and design components based on a user's access level. In this example, there are only three defined levels, administrator 302, layout creator 304 and team member 306. The administrator 302 can assign the hierarchy levels for each project. This allows the administrator 302 to increase or limit the number of hierarchical levels with respect to the project. As will be understood by those with skill in the art with reference to this disclosure, other access levels are possible. This example is meant to be illustrative and not limiting.

Referring now to FIG. 4, there is shown a screenshot of branding capital 400 created by the system of FIG. 1. As can be seen, the completed branding capital 400 comprises every marketing piece that a company could use to promote itself. Using the system 100, all the branding capital 400 items are completely homogeneous, thereby removing the possibility of off message marketing. This makes it easy for a company to reuse and create marketing material for the company without worrying about approvals, because all the branding capital 400 has been pre-approved for use. This decreases time to market and allows the company to hire outside marketing to promote the company using the branding capital 400.

The branding capital 400 (e.g. fonts/logos/colors) can be located at a third party market place. Any branding capital 400 used from the third party market place will automatically update branding capital 400 used by the team. Brand colors, fonts, logos, for example, will automatically be updated when they are changed in the third party marketplace. Additionally, the branding capital 400 can include other guidelines about brand asset usage that may be constrained automatically based on the license purchase at the third party marketplace or by indicia of user roles set up by the team administer 302.

The third party marketplace can include layouts comprised of: fonts, illustrations, backgrounds, images from contributing photographers, illustrations from illustrators, videos, animations, and pages among others.

The layouts that can be created for, but are not limited to: social media graphics, presentations, websites, printed marketing materials (e.g. flyers, brochures), pitch decks and more.

Team members can use the layouts authorized by the administrator 302, but use can be constrained in the layout itself to ensure that is ‘on-brand’, for example:
a) Text boxes may not be able to have their position altered.
b) Text boxes may only be able to expand in a certain direction, for example, down, left, right or the text may only be able to shrink.
c) Images may be locked and not able to be moved. Their filter may not be able to be altered.
d) User may not be able to alter the fonts, font size or text color.
e) There may be a maximum character limit in text boxes.

Amongst other constraints.

Referring now to FIG. 5, there is shown a screenshot of a team administrator 600 page. This is the first step to creating a team homepage and producing brand capital. An administrator 302 for the team creates the account by signing into the system. Once the administrator 302 has been created, the administrator 302 can begin to create a team to work on, or create, the branding capital 400 for the company or project. The administrator 302 is responsible for setting up the team, defining the branding kit to be edited or created, and adding any new members.

Referring now to FIG. 6, there is shown a screenshot of a team portal 600. Once the team has logged onto the system, they can log onto a team homepage. Each team page is different. This allows multiple people to work on multiple projects simultaneously while maintaining separation between the projects. Additionally, a team color can be selected to quickly identify the project for the team members to help maintain the workflow of team members working on multiple projects. Because the system 100 is distributed, team members can be located anywhere in the world. This provides obvious advantages of static in-house solutions currently available. The lack of centralized teams is a major drawback to prior art systems.

Referring now to FIG. 7, there is shown a screenshot of a team page 700 for inviting additional team members. Administrators 302 and other authorized team members can invite various other people to join the team. The invited team members can be from a variety of company functions, such as, for example, sales people, administrative staff, even test groups, in addition to traditional “design” team members. This can provide useful feedback during the various design phases before the final branding capital is completed. Because each team member is assigned a role, there are controls in place for altering the branding capital 400.

Referring now to FIG. 8, there is shown a screenshot of a team's brand kit 800. The team administrators 302 can restrict the branding capital 400 design elements used by the team. The administrator 302 will select the branding capital 400 design elements prior to inviting team members. Alternatively, the branding capital 400 design elements can be constructed/edited throughout the process if no specified color/branding scheme has been designated. This way a consistent look and feel can be achieved from the outset of the project or developed over time to become a standard for the company or the project. The design elements include the colors, fonts, sizes, images, graphics and other assets that comprise the branding capital 400.

Referring now to FIG. 9, there is shown a screenshot of a team's color palette 900. The color palette 900 can similarly be restricted by the administrator 302 or other team members with proper authorization. This restricts the branding capital 300 to only those colors authorized for the design to insure consistency, enabling the team to concentrate on the design without having to select a color palette.

Referring now to FIG. 10, there is shown a screenshot of a color palette selector module 1000. If there are no restrictions on the color palette 900, then the color palette selector module 1000 comprises instructions operable on a processor on the one or more than one computing device 102 and 104 to change the color and submit it to the team for review. The executable instructions comprise displaying various color choices in a simple user interface. The colors are selected and can be saved locally on the one or more than one computing device 102 and 104, or on the remote storage 106 for use by the team. The color palette selector module 1000 comprises general color selection circles 1002. Once one of the general color selection circles 1002 is chosen, the main color selector 1004 appears with all variations of the general color selection circle 1002 selected. The user can then move a cursor around the main color selector to achieve the color desired for the project. The color can be saved either locally or remotely and then used in the project. However, if the user does not have rights granted by the administrator 302, the color palette selector module 1000 will not be shown and only the color palette available in the branding capital 400 will be shown to the team member. This insures that unauthorized color palette changes do not occur and a consistent look is maintained for the project.

Referring now to FIG. 11, there is shown a screenshot of a font selection module 1100. The font selection module comprises instructions executable on the processor for selecting, uploading or editing fonts from local storage or remote storage 106. Once the fonts have been created, they are available to the team on the team homepage for use to create the branding capital 400. This prevents other programs that don't have a particular font from substituting in a font and changing the design, project or marketing materials. The font is stored for use by all the team members and is consistent throughout the branding capital 400.

Referring now to FIG. 12, there is shown a screenshot of a font editor module 1200. The font editor module comprises instructions executable on the processor for creating new fonts or editing existing fonts. This module is only accessible with proper authorization from the administrator 302 to reduce changes to the branding capital 400. However, once authorized, the changed font is immediately updated throughout the design. This saves the time of having to manually re-create or edit each individual design element of the branding capital 400. This also increases the flexibility of the branding capital 400 as it can be applied across various international divisions using fonts of the same type, but in a different language. As can be seen, the font editor module 1200 allows authorized users to search images, font and adjust the color of both to match or create the branding capital 400. Various layouts for the fonts and the branding capital 400 can also be selected.

Referring now to FIG. 13, there is shown a screenshot of a template selection module 1300. The template selection module 1300 comprises instructions executable on the processor for selecting one or more than one pre-made templates to begin the design of the branding capital 400. Optionally, a blank template can be selected and the team can then design/create a new template that is stored in the local storage or the remote storage 106. The selected template can also be made available to the current team or even other teams working on different projects. Additionally, a new template can be uploaded into the system and shared. This allows outside contractors to develop a basic layout for a project and, once complete, have it uploaded to the appropriate project for use by the team.

Referring now to FIG. 14, there is shown a screenshot of a template creation module 1400. As can be seen, the template creation module 1400 comprises instructions executable on the processor for taking standard templates and using various design elements from them to create a new template that is then stored for use throughout the branding capital 400. Various dimensions can be selected and used as a base for new projects or nearly completed projects that only need minor adjustments for a quick turn-around. For example, if a company has a social media branded design that is use for all posts, the basic design will always remain the same. Since the colors, fonts and design elements are already in place, an end user only would need to change the words in the post without worrying that the branding was off message. This can save many hours of trying to recreate a design, or hoping that the person charged with getting the posting up quickly has a copy of the design readily available. As can be seen, the stored designs, templates and other marketing material can be shown to users with minimal authorization to be used on a regular basis without having to search through files to find the last design used. The system 100 also prevents changes in branding keeping the project on track with company goals.

Referring now to FIG. 15, there is shown a screenshot of a template description and security setting module 1500. The template description and security module 1500 comprises instructions executable on the processor for entering a description and other pertinent information for the template used in the branding capital 400. Additionally, the template can be restricted from being shared, or only shared with selected roles or selected team members until the template is finalized. If the design is marked private, it will only be available to select team members to view or use, depending on the user's permission level. If the design is marked as public, the design will be able to be shared with others locally or globally. Graphic artists can independently create designs and upload them to the system 100 where they can be licensed for use in a manner described in U.S. patent Ser. No. 14/777,071. This enables smaller organizations to have access to professionally created graphic designs at a reasonable cost. Graphic artists also benefit from the licensed use of their designs and can be asked by the licensee for additional work or modifications. The system 100 can bring disparate entities together to create a common branding kit or marketing material, quickly, easily and less expensively than hiring a marketing firm.

Referring now to FIG. 16, there is shown a screenshot of an image editor module 1600. The image editor module comprises instructions executable on the processor for retrieving multimedia from local storage or the remote storage 106, uploading multimedia and editing the selected multimedia. Multimedia assets can be purchased, uploaded or retrieved. Licensing of the multimedia assets can be strictly enforced by the administrator 302 setting the appropriate settings in the administrator's panel thereby avoiding licensing and copyright issues.

Referring now to FIG. 17, there is shown a screenshot of a payment option module 1700. The payment option module comprises instructions executable on the processor for selecting a payment plan. For example, if this is a onetime use to create brand capital, a customer can select that option. If this is an ongoing concern, then the customer can select a more appropriate payment option, such as, for example, a monthly charge.

Referring now to FIG. 18, there is shown a screenshot of a payment module 1800. The payment module comprises instructions executable on the processor for entering payment information to retrieve the branding capital from the system. The system will watermark all the branding capital until proper payment is received and verified. This way, the company can review watermarked versions of the branding capital 400, but can only publish the branding capital 400 without the watermarks once payment is made.

Referring now to FIG. 19, there is shown a screenshot of a new design font combination module 1900.

Referring now to FIG. 20, there is shown a screenshot of the team homepage 2000 with the selected design from FIG. 19.

Referring now to FIG. 21, there is shown a screenshot of pre-sized design types 2100 selectable for use in a design. Authorized team members can select from a variety of pre-sized design types for use in the branding capital 400. This provides the ability to quickly make branding capital 400 on short notice or as a starting point for the design.

Referring now to FIG. 22, there is shown a screenshot of a branding capital 400 color palette selection module 2200. The branding capital 400 color palette selection module 2200 comprises instructions executable on the processor for selecting the color of the text that is used in the branding capital 400. Various text sizes and colors can be stored for use by the team creating the branding capital 400.

Referring now to FIG. 23, there is shown a screenshot of a layout selection module 2300. The layout selection module comprises instructions executable on the processor for selecting, creating and editing the various branding capital 400 layouts used by the team.

Referring now to FIG. 24, there is shown a screenshot of a layout customization module 2400. The layout customization module comprises instructions executable on the processor for changing various options of a selected template. This is useful for the team to create a plurality of options for review and feedback.

Referring now to FIG. 25, there is shown a screenshot of a text selection module 2500. The text selection module comprises instructions executable on the processor for changing the text to match the rest of the branding capital 400 design.

Referring now to FIG. 26, there is shown a screenshot of a contextual text application module 2600. The contextual text application module comprises instructions executable on the processor for adjusting and positioning text in the selected layout. This provides the team member with the option to change the text to any of the authorized texts/fonts/colors set by the administrator 302.

Referring now to FIG. 27, there is shown a screenshot of a background selection module 2700. The background selection module comprises instructions executable on the processor for selecting, creating or editing various backgrounds in the branding capital 400.

Referring now to FIG. 28, there is shown a screenshot of a design sharing module 2800. The design sharing module comprises instructions executable on the processor for team members to share designs with other team members, and other people outside the team with proper authorization.

Referring now to FIG. 29, there is shown a screenshot of a design publishing module 2900. The design publishing module comprises instructions executable on the processor for publishing a completed design to various formats. Once created, the branding capital 400 can be published by any authorized user. This is very desirable to people traveling that do not want to carry marketing material. Branded marketing material can be accessed and created at any hotel with a business center or office supply store or printers.

Referring now to FIG. 30, there is shown a screenshot of a design streaming module 3000. Once a design is complete, it is saved to the team homepage where the design streaming module comprises instructions executable on the processor for displaying the design and notifying other team members of the update to the design team homepage. This communication and streaming of the design decreases response time for team members waiting for a particular edit or branding capital 400 element to be made available for them to work on.

Referring now to FIG. 31, there is shown a screenshot of a stream of designs 3100 on the team's homepage.

Referring now to FIG. 32, there is shown a screenshot of a first multi-user design collaboration system 3200 for creating branding capital 400 workflow step. First, the basic fonts, colors and other design elements are selected for the branding capital kit.

Referring now to FIG. 33, there is shown a screenshot of a second multi-user design collaboration system 3300 for creating branding capital 400 workflow step. Next, a team is created to work on the branding capital 400.

Referring now to FIG. 34, there is shown a screenshot of a third multi-user design collaboration system 3400 for creating branding capital workflow step. Then, invitations are sent to the team members so that they can access the team homepage.

Referring now to FIG. 35, there is shown a screenshot of a fourth multi-user design collaboration system 3500 for creating branding capital 400 workflow step. Next, team member roles are assigned, such as, for example, administrator 302, designer, etc.

Referring now to FIG. 36, there is shown a screenshot of a fifth multi-user design collaboration system 3600 for creating branding capital 400 workflow step. Then, the team designer is chosen.

Referring now to FIG. 37, there is shown a screenshot of a sixth multi-user design collaboration system 3700 for creating branding capital 400 workflow step. Next, templates are selected for the branding capital 400. As noted above, new templates can be created in addition to templates already available in local storage or the remote storage 106.

Referring now to FIG. 38, there is shown a screenshot of a seventh multi-user design collaboration system 3800 or creating branding capital 400 workflow step. Then, the team can access all the design elements from the team homepage and work on the branding capital 400.

Referring now to FIG. 39, there is shown a screenshot of an eighth multi-user design collaboration system 3900 for creating branding capital 400 workflow step. Next, different team homepage colors can be used to differentiate between projects. This color coding makes it easier to manage multiple projects where there are common team members.

Referring now to FIG. 40, there is shown a screenshot of a tenth multi-user design collaboration system 4000 for creating branding capital 400 workflow step. Then, a layout is selected or created.

Referring now to FIG. 41, there is shown a screenshot of an eleventh multi-user design collaboration system 4100 for creating branding capital 400 workflow step. Next, a description of the template is added to the template metadata and stored in the local storage or the remote storage 106.

Referring now to FIG. 42, there is shown a screenshot of a twelfth multi-user design collaboration system 4200 for creating branding capital 400 workflow step. Then, a color selection module is used to create the brand capital's 400 color scheme.

Referring now to FIG. 43, there is shown a screenshot of a thirteenth multi-user design collaboration system 4300 for creating branding capital 400 workflow step. Next, text is added to the branding capital 400. As will be understood by those with skill in the art with reference to this disclosure, various textual elements, such as, size, shape and color, are adjusted in this step.

Referring now to FIG. 44, there is shown a screenshot of a fourteenth multi-user design collaboration system 4400 for creating branding capital 400 workflow step. Then, the completed template is stored to the system.

Referring now to FIG. 45, there is shown a screenshot of a fifteenth multi-user design collaboration system 4500 for creating branding capital 400 workflow step. Next, various other templates can be selected and used to create “what if” designs or alternative designs for use in the branding capital 400.

Referring now to FIG. 46, there is shown a screenshot of a sixteenth multi-user design collaboration system 4600 for creating branding capital 400 workflow step. Finally, the template is reviewed and can either be rejected (deleted) or revised (edited).

What has been described is a new and improved multi-user design collaboration system for creating branding capital 400, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, can be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

1. A method, wherein the method is carried out by a computer system connected to a network and to a plurality of electronic devices, including a first electronic device with a first display and a second electronic device with a second display, different to the first electronic device with the first display, the method comprising:
causing the first electronic device to display on the first display device, a first user interface for a first user, the first user interface including respective display regions simultaneously displaying at least two of:
a set of colors, the set of colors including one or more existing set colors, and a selectable indicium associated with an operation of editing the set of colors;
a set of fonts, the set of fonts including one or more existing set fonts, and a selectable indicium associated with an operation of editing the set of fonts; and
a set of logos, the set of logos including one or more existing set logos, and a selectable indicium associated with an operation of editing the set of logos;
causing the storing, in a storage and retrieval system, of the at least two of the set of colors, fonts or logos associated with one or more design templates or designs that incorporate the stored colors, fonts and/or logos;
in response to user interaction with the first user interface to complete the editing operation, adding a color or font or logo to its respective set and displaying the added color, font or logo simultaneously with one or more existing set colors, fonts or logos respectively in a design kit;
causing the update, in the storage and retrieval system, of the at least two of the set of colors, fonts or logos to include the added color, font or logo while maintaining the association with the one or more design templates or designs that incorporate the stored colors, fonts and/or logos; and
causing the second electronic device to display on the second display device, a second user interface for a second user different to the first user, the second user interface including a display region in which the one or more design templates or designs are displayed and a distinct display region in which the updated stored set of colors, fonts or logos of the design kit are displayed for use in editing the one or more design templates or designs.

2. The method of claim 1, wherein the operation of editing a color, font or logo to add a color, font or logo to its respective set is available via the first user interface and not the second user interface.

3. The method of claim 1, wherein the display region in which the one or more design templates are displayed includes an indicium associated with an operation of adding a new design template and wherein the method includes storing, in the storage and retrieval system, a new design template created by the operation of adding a new design template as a template associated with the design kit.

4. The method of claim 3, wherein the second user interface provides access to a function of the second user to enter a design into the new design template.

5. The method of claim 4, further comprising in response to user interaction with the second user interface, storing the design in the storage and retrieval system, and subsequently causing a user interface for a plurality of other users of the computer system to display the design for use by the other users.

6. The method of claim 1, including in response to user interaction with the first user interface to complete an editing operation that edits a font in the set of fonts, updating the font in at least one of the associated design templates or designs.

7. The method of claim 1, wherein the one or more design templates or designs that incorporate the stored colors, fonts and/or logos includes at least one design template or design that incorporates a first font that is of the same type as a second font that is in the set of fonts, but is in a different language to the first font.

8. The method of claim 7, including in response to user interaction with the first user interface to complete a said editing operation that edits the second font, updating the first font in the at least one design template or design that incorporates the first font.

9. The method of claim 1, wherein the first user interface includes a distinct display region in which the one or more design templates are displayed.

10. The method of claim 9, wherein the display region in which the one or more design templates are displayed includes an indicium associated with an operation of adding a new design template and wherein the method includes storing, in the storage and retrieval system, a new design template created by the operation of adding a new design template associated with the design kit.

11. The method of claim 10, wherein the display region of the second user interface in which the one or more design templates or designs are displayed includes the new design template.

12. The method of claim 11, wherein the operation of adding a new design template includes displaying in the first user interface a selectable indicium for the new design template, wherein the display in the second user interface of the new design template is caused by and dependent on selection of the selectable indicium.

13. The method of claim 12, wherein the display in the second user interface of the new design template is also dependent on a determination, by the computer system, that the first user and the second user have a predefined association recorded in the storage and retrieval system or another storage and retrieval system of the computer system.

14. The method of claim 1, further comprising in response to user interaction with the first user interface to complete a said editing operation changing a color or font or logo in its respective set, displaying in the first user interface the changed color, font or logo simultaneously with other existing set colors, fonts or logos respectively and automatically updating the stored one or more design templates or designs that incorporate the changed color or font or logo to use the changed color or font or logo respectively.

15. A non-transitory computer-readable medium having stored thereon program instructions that upon execution by a computer system connected to a network to a plurality of electronic devices, including a first electronic device with a first display and a second electronic device with a second display, different to the first electronic device with the first display, cause performance of operations, the operations comprising:
causing the first electronic device to display on the first display device, a first user interface for a first user, the first user interface including respective display regions simultaneously displaying at least two of:
a set of colors, the set of colors including one or more existing set colors, and a selectable indicium associated with an operation of editing the set of colors;
a set of fonts, the set of fonts including one or more existing set fonts, and a selectable indicium associated with an operation of editing the set of fonts; and
a set of logos, the set of logos including one or more existing set logos, and a selectable indicium associated with an operation of editing the set of logos;
causing the storing, in a storage and retrieval system, of the at least two of the set of colors, fonts or logos associated with one or more design templates or designs that incorporate the stored colors, fonts and/or logos;
in response to user interaction with the first user interface to complete the editing operation, adding a color or font or logo to its respective set and displaying the added color, font or logo simultaneously with one or more existing set colors, fonts or logos respectively in a design kit;
causing the update, in the storage and retrieval system, of the at least two of the set of colors, fonts or logos to include the added color, font or logo while maintaining the association with the one or more design templates or designs that incorporate the stored colors, fonts and/or logos; and
causing the second electronic device to display on the second display device, a second user interface for a second user different to the first user, the second user interface including a display region in which the one or more design templates or designs are displayed and a distinct display region in which the updated stored set of colors, fonts or logos of the design kit are displayed for use in editing the one or more design templates or designs.

16. The non-transitory computer-readable medium of claim 15, wherein the operation of editing a color, font or logo to add a color, font or logo to its respective set is available via the first user interface and not the second user interface.

17. The non-transitory computer-readable medium of claim 15, wherein the display region in which the one or more design templates are displayed includes an indicium associated with an operation of adding a new design template and wherein the method includes storing, in the storage and retrieval system, a new design template created by the operation of adding a new design template as a said template associated with the design kit, wherein the second user interface provides access to a function of the second user to enter a design into the new design template and the operations further comprise in response to user interaction with the second user interface, storing the design in the storage and retrieval system, and subsequently causing a user interface for a plurality of other users of the computer system to display the design for use by the other users.

18. The non-transitory computer-readable medium of claim 15 wherein the operations include, in response to user interaction with the first user interface to complete an editing operation that edits a font in the set of fonts, updating the font in at least one of the associated design templates or designs.

19. The non-transitory computer-readable medium of claim 15, wherein the one or more design templates or designs that incorporate the stored colors, fonts and/or logos includes at least one design template or design that incorporates a first font that is of the same type as a second font that is in the set of fonts, but is in a different language to the first font and the operations include, in response to user interaction with the first user interface to complete an editing operation that edits the second font, updating the first font in the at least one design template or design that incorporates the first font.

20. The non-transitory computer-readable medium of claim 15, wherein the first user interface includes a distinct display region in which the one or more design templates are displayed, the display region in which the one or more design templates are displayed includes an indicium associated with an operation of adding a new design template and wherein the method includes storing, in the storage and retrieval system, a new design template created by the operation of adding a new design template associated with the design kit, the display region of the second user interface in which the one or more design templates or designs are displayed includes the new design template, the operation of adding a new design template includes displaying in the first user interface a selectable indicium for the new design template, wherein the display in the second user interface of the new design template is caused by and dependent on selection of the selectable indicium.
